(19) United States
(12) Patent Application Publication
(10) Pub. No.: US 2003/0103224 A1
(43) Pub. Date: Jun. 5, 2003

(54) Adaptive print driver selection systems and methods

(76) Inventors: Bruce L. Johnson, Eagle, ID (US); Bradley J. Anderson, Boise, ID (US); Leonard T. Schroath, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/000,015

(22) Filed: Dec. 4, 2001

(51) Int. Cl. B41B 1/00; G06F 15/00

(52) U.S. Cl. 358/1.13

(57) ABSTRACT

Systems and methods of an adaptive print driver system are disclosed. A representative adaptive print driver system includes a page description language driver selection system. The page description language driver selection system is configured to receive information corresponding to a print task and determine the document type for the print task. Further, the page description language driver selection system is configured to determine a page description language driver based upon the document type that is to be used to convert the information corresponding to the print task to information corresponding to the print task exhibiting the page description language.

### TECHNICAL FIELD

The present invention is generally related to print drivers and, more particularly, is related to systems and methods for selecting appropriate page description language drivers.

### BACKGROUND OF THE INVENTION

Generally, a computer can be used to select a print task having a particular document type to be printed by a printer. Before the print task is printed, a page description language driver converts the information corresponding to the print task into a page description language that the printer uses to print the print task. Typically, the printer manufacturer provides one or more page description language drivers to facilitate printing. Initially, however, only one page description language driver is usually selected when the printer is interfaced with the computer. The initially selected page description language driver is used to print all print tasks regardless of the document type.

Print tasks having certain document types are more efficiently and effectively printed using a particular page description language. For example, the Postscript page description language is better suited to printing from Adobe graphics applications. Consequently, if the computer is not using a Postscript page description language driver, then the printer is not capable of printing the print task as efficiently and effectively as possible.

One solution to this problem is manually selecting the most effective driver page description language each time a printing request is made. However, this solution is not satisfactory because selecting the most appropriate page description language driver requires knowledge and skill that most users do not have. Therefore, most printers are not used in an effective and efficient manner.

Thus, a heretofore unaddressed need exists in the industry to address the aforementioned and/or other deficiencies and/or inadequacies.

### SUMMARY OF THE INVENTION

A representative adaptive print driver system of the present invention includes a page description language driver selection system. The page description language driver selection system is configured to receive information corresponding to a print task and determine the document type for the print task. Further, the page description language driver selection system is configured to determine a page description language driver based upon the document type that is to be used to convert the information corresponding to the print task to information corresponding to the print task exhibiting the page description language.

The present invention also involves methods for selecting a print driver. The method includes: receiving information corresponding to a print task, wherein the print task exhibits a document type; determining the document type for the print task; and selecting a page description language driver based upon the document type that is to be used to convert the information corresponding to the print task such that after conversion the information corresponding to the print task exhibits the page description language selected.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a schematic diagram of a print system of the present invention.

FIG. 1B is a flow diagram that illustrates the path of a print task through the print system shown in FIG. 1A.

FIG. 2A is a schematic diagram of an embodiment of an adaptive print driver system of the present invention.

FIG. 2B is a flow diagram illustrating representative functionality of the adaptive print driver system shown in FIG. 2.

FIG. 3 is a schematic diagram of one embodiment representative of the adaptive print driver system illustrated in FIG. 2A.

FIG. 4 is a flow diagram illustrating representative functionality of an embodiment of the page description language selection system illustrated in FIGS. 2A and 3.

FIG. 5 is a flow diagram illustrating representative functionality of an embodiment of the adaptive print driver system illustrated in FIG. 2A.

### DETAILED DESCRIPTION

Adaptive print driver systems and methods of the present invention are configured to select a page description language (PDL) driver that enables the printer to effectively and efficiently print a print task. Because of this, a user does not have to manually select an appropriate PDL driver for a particular document type each time the user prints a print task. In this manner, the invention can facilitate the efficient and effective use of a printer because the printer receives the information corresponding to the printing task exhibiting a selected PDL.

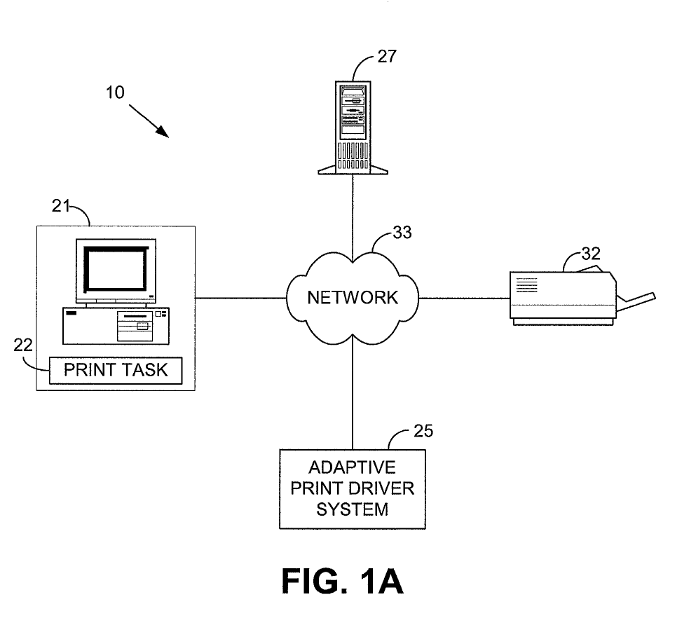

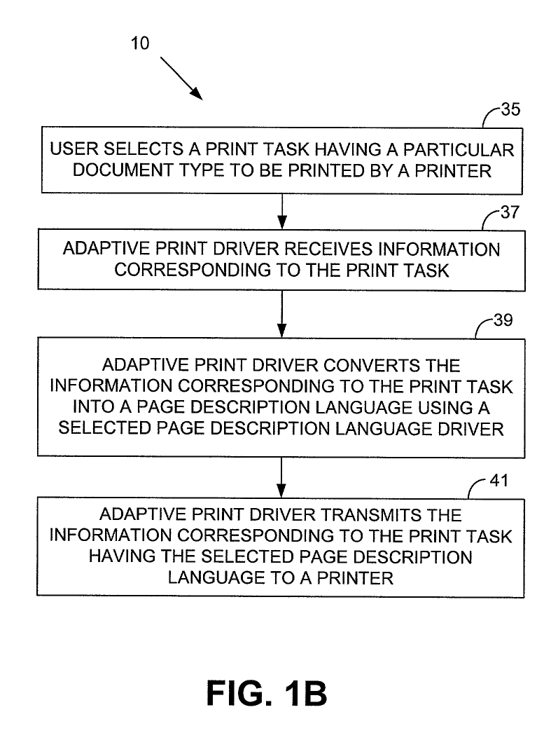

Now referring to the figures, FIG. 1A is a schematic diagram of a print system 110. The print system 10 includes a computer 21 that may include a print task 22 that exhibits a particular document type, an adaptive print driver system 25, a server 27, and a printer 32, communicatively coupled via a network 33. As used herein, the term document type refers to a file with a specific file architecture such as, for example, Adobe Photoshop, Microsoft Word, Microsoft Excel, Visio, Forms applications, and legacy applications (pre-1995 documents).

The network 33 can be one or more networks capable of enabling the above components to communicate and may include, for example, local area network (LAN), wireless local area network (WLAN), a metropolitan area network (MAN), a wide area network (WAN), any public or private packet-switched or other data network, including the Internet, circuit-switched networks, such as the public switched telephone network (PSTN), wireless networks, a 1284 printer interface, USB interface, infrared interface, or any other desired communications infrastructure.

FIG. 1B is a flow diagram illustrating how the information corresponding to a print task flows through the print system 10. In block 35, the user uses a computer 21 to select a print task to be printed by a printer 32. The information corresponding to the print task is routed to the adaptive print driver system 25. The adaptive print driver system 25 is configured to receive information corresponding to the print task, as shown in block 37. The adaptive print driver system 25 may be located on the computer 21, server 27, printer 32, etc. In addition, the adaptive print driver system 25 is configured to convert the information corresponding to the print task into information corresponding to the print task exhibiting the selected PDL, as shown in block 39. Then the adaptive print driver system 25 is configured to use a selected PDL driver to convert the information corresponding to the print task to information corresponding to print task exhibiting the selected PDL. Thereafter, the adaptive print driver system 25 is configured to transmit the converted information corresponding to the print task exhibiting the selected PDL to a printer 32, as shown in block 41.

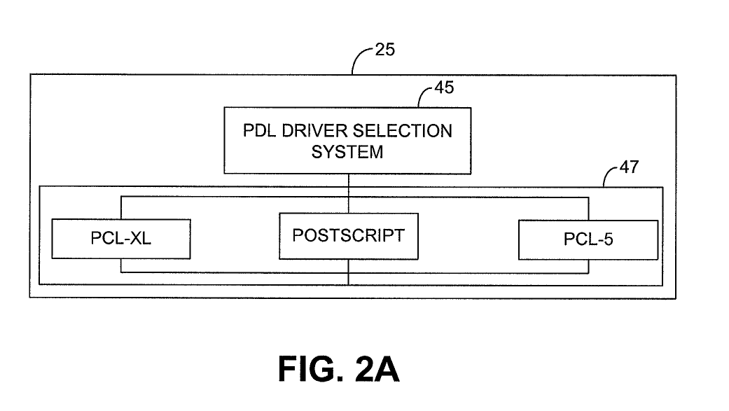

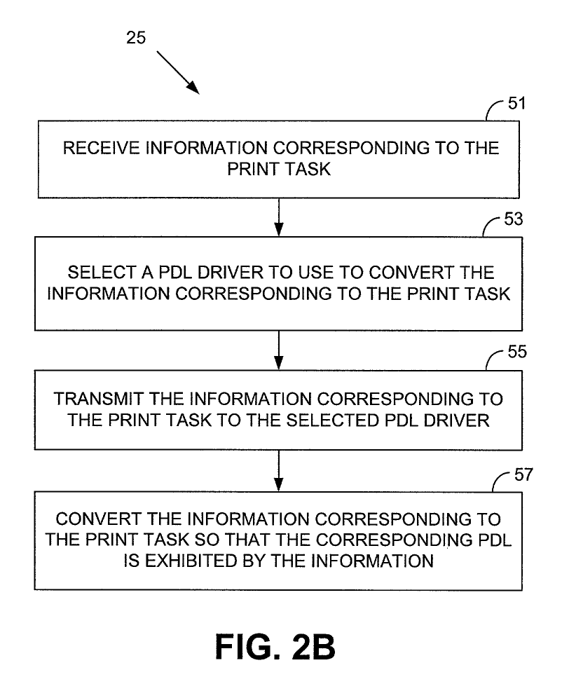

FIG. 2A is a schematic diagram of a representative embodiment of the adaptive print driver system 25. The adaptive print driver system 25 includes a PDL driver selection system 45. In the embodiment depicted, the adaptive print driver system 25 includes three PDL drivers 47. Note, other embodiments of the adaptive print driver system 25 may include a different number (2 or more) of PDL drivers 47.

FIG. 2B is a flow diagram that illustrates the functionality of a representative embodiment of the adaptive print server system 25 depicted in FIG. 2A. The PDL driver selection system 45 is configured to receive information corresponding to the print task, as shown in block 51. In addition, the PDL driver selection system 45 is configured to select a PDL driver 47 to use to convert the information corresponding to the print task to the appropriate PDL, as shown in block 53. The PDL driver selection system 45 is configured to transmit the information corresponding to the print task to the selected PDL driver 47, as shown in block 55. Thereafter, the selected PDL driver 47 converts the information corresponding to the print task to information corresponding to the print task exhibiting the corresponding PDL of the PDL driver, as shown in block 57.

As indicated above, the adaptive print driver system 25 includes a PDL driver selection system 45. The PDL driver selection system 45 can be implemented in software (e.g., firmware), hardware, or a combination thereof. The adaptive print driver system 25 can be implemented in a special or general-purpose digital computer or a processor-based system (hereinafter “computer 60”). Typically, the PDL driver selection system 45 resides on the host, with the applications and print drivers. However, the PDL driver selection system 45 can reside elsewhere (e.g. server, printer) using the methods used for remote drivers known in the prior art (e.g. metafile spooling)

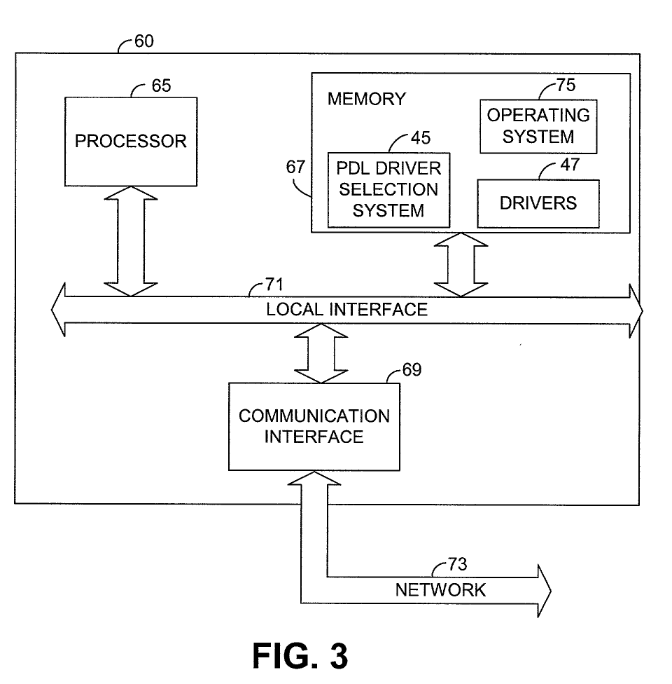

Generally, in terms of hardware architecture, as shown in FIG. 3, computer 60 includes a processor 65, memory 67, and a communication interface 69 that are communicatively coupled via a local interface 71. The local interface 71 can be, for example, one or more buses or other wired or wireless connections, as is known in the art. The local interface 71 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The computer 60 may be interfaced to one or more devices, via the communication interface 69 such as a computer, printer, or server, via a network 33.

The processor 65 is a hardware device for executing software, particularly that stored in memory 67. The processor 65 can be any custom made or commercially available processor, a central processing unit (CPU), an auxiliary processor among several processors associated with computer 60, a semiconductor based microprocessor (in the form of a microchip or chip set), a macroprocessor, or generally any device for executing software instructions.

The memory 67 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 67 may incorporate electronic, magnetic, optical, and/or other types of storage media. Note that the memory 67 can have a distributed architecture, where various components are situated remote from one another, but can be accessed by the processor 65.

The software in memory 67 may include one or more separate programs, each of which comprises an ordered listing of executable instructions for implementing logical functions. In the example of FIG. 3, the software in the memory 67 includes the PDL driver selection system 45 and a suitable operating system 75 (O/S). The operating system 75 essentially controls the execution of other computer programs, such as the PDL driver selection system 45, and provides scheduling, input-output control, file and data management, memory management, and communication control and related services.

The PDL driver selection system 45 can be a source program, executable program (object code), script, or any other entity comprising a set of instructions to be performed. When a source program, then the program may need to be translated via a compiler, assembler, interpreter, or the like, which may or may not be included within the memory 67, so as to operate properly in connection with the O/S 75. Furthermore, the PDL driver selection system 45 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The computer 60 may further include a basic input output system (BIOS) (omitted for simplicity). The BIOS is a set of essential software routines that initialize and test hardware at startup, start the O/S 75, and support the transfer of data among the hardware devices. The BIOS is stored in ROM so that the BIOS can be executed when the computer 60 is activated.

When the computer 60 is in operation, the processor 65 is configured to execute software stored within the memory 67, to communicate data to and from the memory 67, and to generally control operations of the computer 60 pursuant to the software. The PDL driver selection system 45 and the O/S 75, in whole or in part, but typically the latter, are read by the processor 65, perhaps buffered within the processor 65, and then executed.

When the PDL driver selection system 45 is implemented in software, as is shown in FIG. 3, it should be noted that the PDL driver selection system 45 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The page description driver selection system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, by way of optical scanning of the paper or other medium, then compiled, interpreted or otherwise processed in a suitable manner if necessary, and then stored in a computer memory.

In an alternative embodiment, where the PDL driver selection system 45 is implemented in hardware, the PDL driver selection system 45 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The computer 60 can include one or more PDL drivers 47. The embodiment illustrated in FIG. 3 includes three PDL drivers 47. The PDL driver 47 may include, for example, Postscript, PCL-XL, PCL-5, PCL-5c, PCL-5e, PCL-3, and HPGL PDL drivers. The PDL driver selection system 45 selects the PDL driver 47 for the particular print task document type.

In general, Adobe document types are more effectively and efficiently converted by a Postscript PDL driver. Microsoft Word and Excel, and Visio document types are more effectively and efficiently converted by a PCL-XL PDL driver. Forms and legacy (pre-1995) document types are more effectively and efficiently converted by a PCL-5 PDL driver.

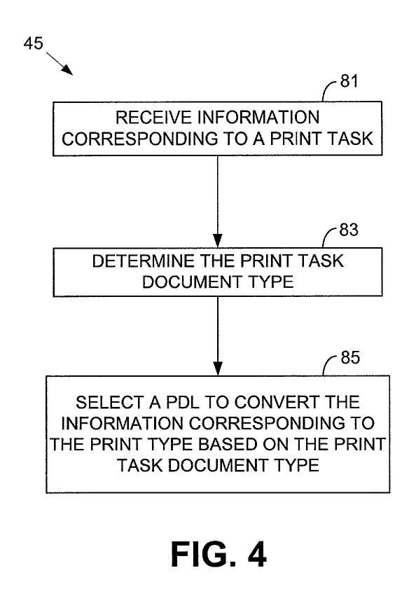

Reference will now be made to the flow diagram of FIG. 4, FIG. 4 illustrates the functionality of a representative embodiment of the PDL driver selection system 45. In this regard, each block of the flow diagram represents a module segment, portion of code, or logic circuit(s) for implementing the specified logical function(s). It should also be noted that in some alternative implementations the functions noted in various blocks of FIG. 4, or any other of the accompanying flowcharts, may occur out of the order in which they are depicted. For example, two blocks shown in succession in FIG. 4 may, in fact, be executed substantially concurrently. In other embodiments, the blocks may sometimes be executed in the reverse order depending upon the functionality involved.

PDL driver selection system 45 is an exemplary system for performing the functionality described in FIG. 4. Information corresponding to a printing task having a particular document type is received, as shown in block 81. In addition, the printing task document type is determined, as shown in block 83. Then, the PDL driver used to convert the information corresponding to the print type based on the document type is selected, as shown in block 85.

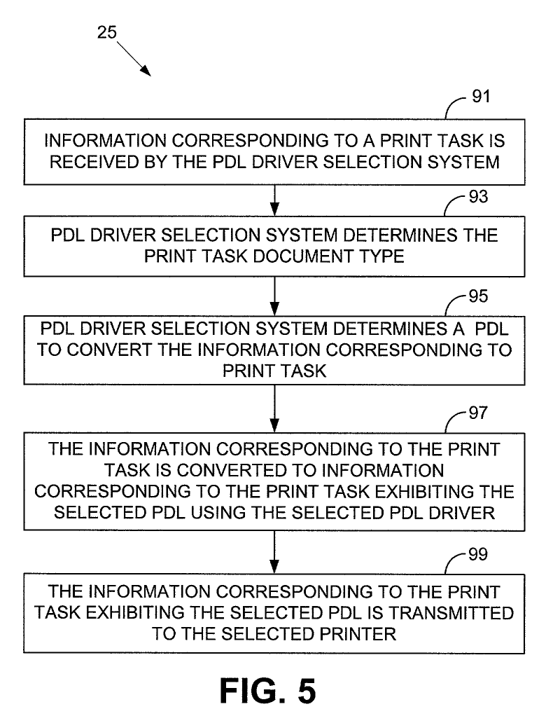

FIG. 5 illustrates the functionality of a representative embodiment of the adaptive print driver system 25. The adaptive print driver system 25 includes a PDL driver selection system 45 that receives the information corresponding to the print task, as shown in block 91. The PDL driver selection system 45 determines the printing task document type, as shown in block 93. Then, the PDL driver selection system 45 selects the PDL driver 47 to use to convert the information corresponding to the printing task, as shown in block 95. Subsequently, the selected PDL driver 47 is used to convert the information corresponding to the print task to information corresponding to the print task exhibiting the PDL corresponding to the selected PDL driver, as shown in block 97. Then, the adaptive print driver system 25 is configured to route the information corresponding to the print task exhibiting the selected PDL to the selected printer 32, as shown in block 99.

Therefore, at least some of the embodiments of the adaptive print driver system 25 can overcome the deficiencies described above because the adaptive print driver system 25 can automatically determine the most effective and efficient PDL print driver to use to convert the print task. This eliminates the need for the user to manually select the most effective and efficient PDL print driver 47 each time the user wants to print a print task.

Many variations and modifications may be made to the above-described embodiment(s) of the adaptive print driver system 25 without departing substantially from the invention. For example, the adaptive print driver system 25 (e.g., the PDL driver selection system 45) can determine the most effective and efficient PDL driver to use to convert a print task of an unknown document type. This can be performed, for example, by converting the information corresponding to the print task using each PDL driver and determining the shortest print time (e.g. time for a printer to print a print task) for the information generated by each PDL driver. Therefore, the adaptive print driver system 25 can use the printer in the most efficient manner. In another example, the adaptive print driver system 25 can select the PDL driver based on shortest print time for all document types. In still another example, the adaptive print driver system 25 can select the PDL driver based on document qualities such as for example, color, image, font, etc. All such modifications and variations are intended to be included herein within the scope of this disclosure and the present invention and protected by the following claims.

1. A method for selecting a print driver comprising:
receiving information corresponding to a print task, wherein the print task exhibits a document type;
determining the document type for the print task; and
selecting a page description language driver based upon the document type that is to be used to convert the information corresponding to the print task such that after conversion the information corresponding to the print task exhibits the page description language selected.

2. The method of claim 1, further comprising:
converting the information corresponding to the print task using the page description language driver.

3. The method of claim 2, further comprising:
sending the information corresponding to the print task having the page description language to a printer.

4. The method of claim 1, wherein determining a page description language driver includes:
determining the page description language driver to convert the information corresponding to the print task based upon predetermined relationships; and
selecting the page description language driver that corresponds to the page description language.

5. The method of claim 4, wherein determining the page description language driver to convert the information corresponding to the print task based upon pre-determined relationships, includes:
selecting a Postscript page description language driver if the document type is an Adobe type document.

6. The method of claim 4, wherein determining the page description language driver to convert the information corresponding to the print task based upon pre-determined relationships, includes:
selecting a PCL-5 page description language driver if the document type is selected from a forms type document and a legacy type document.

7. The method of claim 4, wherein determining the page description language driver to convert the information corresponding to the print task based upon pre-determined relationships, includes:
selecting a PCL-XL page description language driver if the document type is selected from a Microsoft-Word type document, Microsoft-Excel type document, and a Visio type document.

8. The method of claim 1, wherein determining a page description language driver includes:
selecting the page description language driver that results in the shortest print time for the information corresponding to the print task.

9. An adaptive print driver system, comprising:
a page description language driver selection system configured to receive information corresponding to a print task, wherein the print task has a document type; configured to determine the document type for the print task; and configured to determine a page description language driver based upon the document type that is to be used to convert the information corresponding to the print task to information corresponding to the print task exhibiting the page description language.

10. The system of claim 9, further comprising:
at least one page description language driver configured to convert the information corresponding to the print task to information corresponding to the print task exhibiting a page description language.

11. The system of claim 10, wherein the at least one page description language driver is selected from a PCL-5e driver, HPGL driver, PCL-3 driver, PCL-5c driver, PCL-XL driver, and a Postscript driver.

12. The system of claim 10, wherein the page description language driver is configured to send the information corresponding to the print task exhibiting the page description language to a printer.

13. The system of claim 10, wherein the page description language driver is configured to determine the page description language to convert the information corresponding to the print task based upon pre-determined relationships and is configured to select the page description language driver that corresponds to the page description language.

14. The system of claim 10, further comprising:
means for receiving information corresponding to a print task, wherein the print task has a document type;
means for determining the document type for the print task;
means for determining a page description language driver based upon the document type that is to be used to convert the information corresponding to the print task to information corresponding to the print task exhibiting the page description language.

15. The system of claim 10, further comprising:
means for converting the information corresponding to the print task using the page description language driver.

16. The system of claim 10, wherein the page description language driver selection system is implemented in a printer.

17. The system of claim 10, wherein the page description language driver selection system is implemented in a computer.

18. A computer readable medium for use in a computer system for selecting a print driver, said computer readable medium comprising:
logic configured to enable information corresponding to a print task to be received;
logic configured to enable a document type for the print task to be determined; and
logic configured to enable a page description language driver to be determined based upon the document type that is to be used to convert the information corresponding to the print task to information corresponding to the print task having the page description language.

19. The computer readable medium of claim 18, further comprising:
logic configured to enable information corresponding to the print task to be converted using the page description language driver.

20. The computer readable medium of claim 18, further comprising:
logic configured to enable the information corresponding to the print task having the page description language to be sent to a printer.
